(19) United States
(12) Patent Application Publication
(10) Pub. No.: US 2010/0279036 A1
(43) Pub. Date: Nov. 4, 2010

(54) IMPRINT-ABLE HAND HELD FAN/DECOR/STATIONERY KIT

(76) Inventor: Kristye Dorilam Addison Dudley, (US)

Correspondence Address: Kristye Dorilam Addison Dudley, 272 Dellwood Drive, Spartanburg, SC, 29301, US

(21) Appl. No.: 12/435,038

(22) Filed: May 4, 2009

(51) Int. Cl. B32B 29/00

(52) U.S. Cl. 428/32.22

(57) ABSTRACT

The imprint-able hand held fan/decor/stationery kit design for providing customization on ink jet/laser home or office printers. A user can customize each sheet or use the same shape for multiple purposes without professional assistance, therefore increasing production time, and mass production limitations of the same artwork and high quantity minimums. The adhesive backing increasing production time, and allows the user to have a double-sided finished product. Thus a considerably more versatile hand held fan kit is provided-that can be customized to provide a more unique event experience.

### CROSS-REFERENCE TO RELATED APPLICATIONS

This application claims the benefit of provisional patent 61/051,470, filed by the present inventor.

### FEDERALLY SPONSORED RESEARCH

Not Applicable

### SEQUENCE LISTING

Not Applicable

### BACKGROUND

1. Field of Invention

This invention relates to the improved fan kit, specifically the product can be printed and assembled in a home or office with the use of an ink jet or laser printer.

2. Prior Art

Event fans can be expensive to order and often times have high minimum quantities for ordering. They also have limited choices or colors, fonts and layouts for use. Many event/promotional fans are constructed with one side showing the artwork and the back showing a handle, limiting the printable area. Also, many fans are assembled using staples that are unsightly. Promotional fans, by nature, have one application as a fan and cannot easily be repurposed, limiting the end users options for maximizing costs.

U.S. Pat. No. 4,352,630 to Wallo (1982) shows hand fan assembly and kit. This patent claims to improve the conventional assembly of a fan in a vertical folding pattern with a hole for handle insertion. Wallo focuses on the comfort of the handle stem, a socket-type insertion for the handle. The fold forming of the body from a single vertically laid out sheet. Although the single sheet is considered, the size and shape of the sheet are not made with at home consumer use in mind. The substrate is specified for being contained in an envelope of fan body the handle all in a generally rectangular shape. Also the substrate is not designed for ink jet/laser home or office printing.

U.S. Pat. No. 7,303,794 B2 (2007) describes ink jet recording paper. This type of paper has been developed in a number of weights and thicknesses for use with ink jet printers. Laser paper has also been previously developed, both substrates are created to adhere the unique printing properties of the printer and create optimal printing on either ink jet or laser printers. The properties of substrates with specific composition for ink jet/laser printers will aid in the usefulness of the invention.

In conclusion, insofar as I am aware of, no fan kit formerly developed provides pre-cut die shapes and scoring, with adhesive backing formed from an ink jet/laser substrate for the purpose for in home or office printer use.

### SUMMARY

This invention relates to the improved fan kit, the imprint-able hand held fan/decor/stationery kit. The substrate is a pre-cut, pre scored sheet composed of paper prepped for used for in home or in office printing. The pre cut paper has a variety of uses including assembly with the handle for use as a fan, assembly without the handle as imprint-able stationery, combined with other sheets to create decor, such as the mobile. The improvement of the fan is the use of pre-cut shapes, which are made for use in a home or office printer. Adhesive backing also aids in assembly and production time for personal use. This will provide a more efficient way for an individual to produce event fans and/or decor without the use of mass production specifications. Thus creating a unique and custom product for at home or in an office use.

### DRAWINGS—FIGURES

In the drawings, closely related figures have the same number but different alphabetic suffixes.

FIG. 1. Shows one side of the substrate non-laminated various aspects of fan with handle

FIG. 2. Perspective of the backside of substrate, which includes lamination

FIG. 3. View of paper removed from die cut material

FIG. 4. Perspective view of the fan assembly

FIG. 5. Perspective of print side closed fan

FIG. 6 Side view of the fan sheet, handle

FIG. 7 Top view of the fan

FIG. 8 Bottom view of the fan

FIG. 9. Perspective of a finished fan without the handle

FIG. 10. Shows two finished fans without handles combined to create a mobile.

FIG. 11 Lateral cross-sections through mobile

FIGS. 12-16 various shapes for dies (shown with handles)

### DRAWINGS—REFERENCE NUMERALS

18 substrate 34 assembled fan/handle

20 score line 36 substrate

22 die cut/perforation 38 handle

24 handle 40 non handle assembly

26 adhesive backing 42 first printed sheet

28 die cut/perforation separated 44 second printed sheet

30 assembled fold, adhesive, sheet score 46 cut sheet for assembly of mobile

32 assembly of inserting handle 48 hanging apparatus

### DETAILED DESCRIPTION

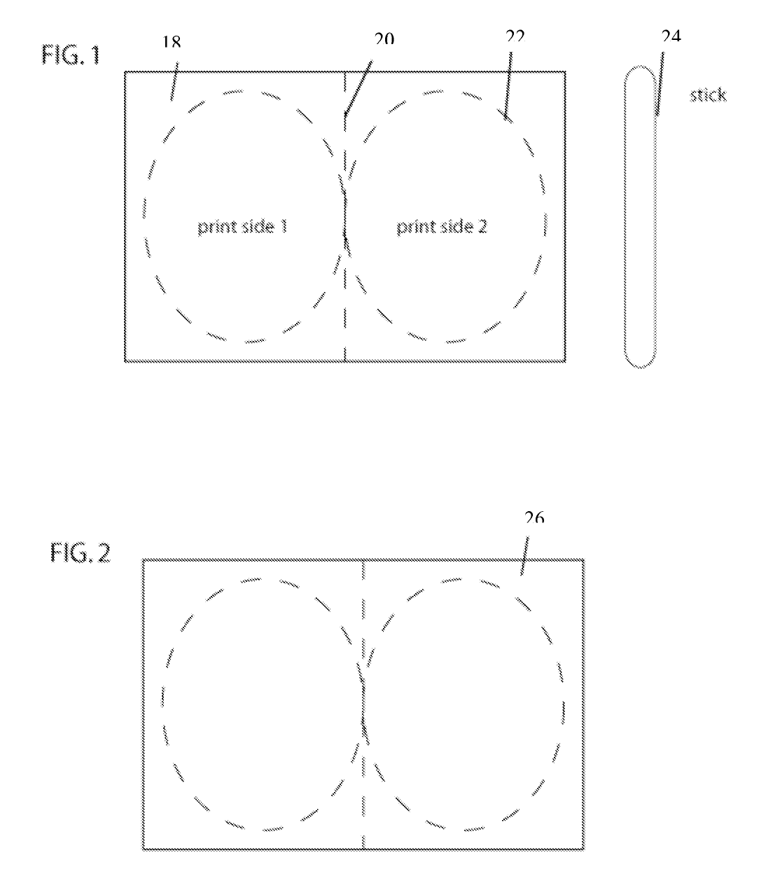

FIG. 1. Perspective of the printable side of the paper constructed in accordance with the invention and the 24 handle. The material 18 is made of ink jet/laser substrate. Each sheet is 20 scored and 22 perforated/die cut to a number of decorative shapes that are mirrored for finishing. Paper weight is determined by the printer standards and hand held fan stability

FIG. 2. Perspective of the back side of the sheet, which carries 26 adhesive for assembly

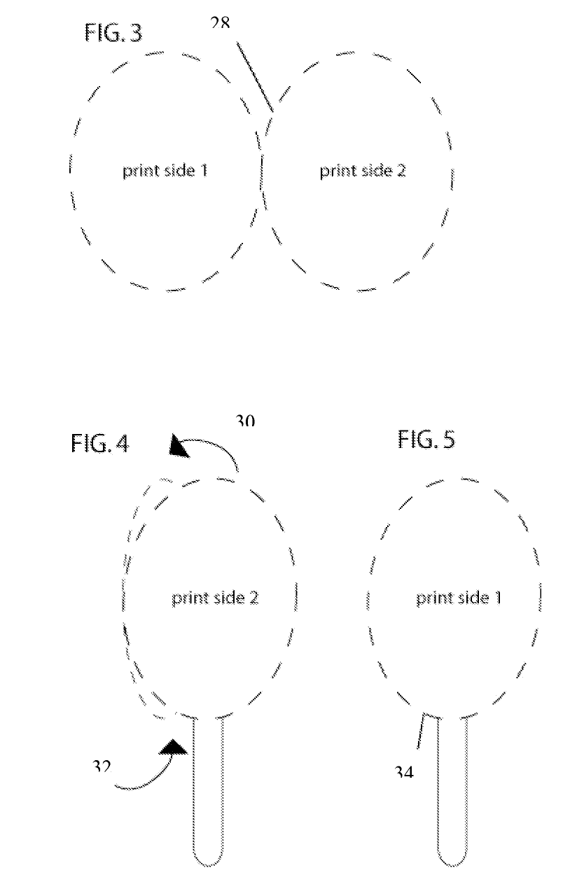

FIG. 3. perspective of view of the printed, 28 clean edge separated shape of the fan.

FIG. 4. perspective view of the fan assembly. To assemble, remove adhesive backing, 30 fold, print side 1 and print side 2. Finally 32 insert stick.

FIG. 5. perspective of print side 1 closed fan. Printing is possible on 34 both sides of fan.

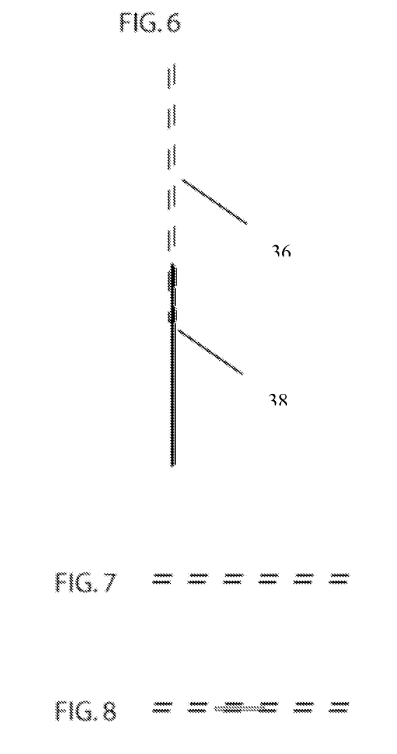

FIG. 6 side view of the fan 36 sheet, 38 handle.

FIG. 7 top view of the fan

FIG. 8 bottom view of the fan

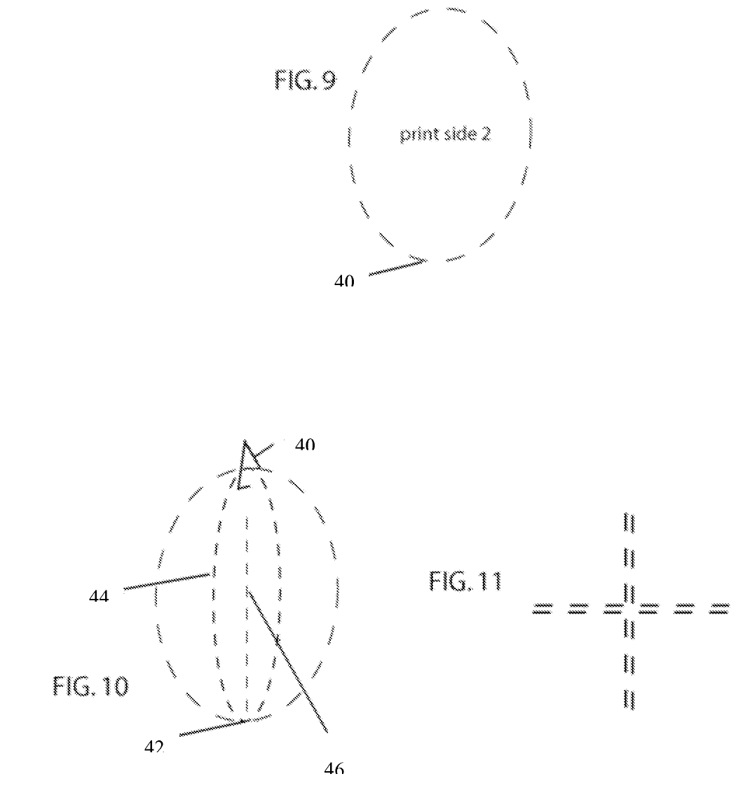

FIG. 9. perspective of a finished fan without the handle 40 as a finished product that can be used as an invitation, program, menu, imprint-able

FIG. 10. perspective of a second finished fans without handles 42 combined to create a mobile. A slit is made 44 and the second sheet is inserted, an apparatus 46 (string and holes) are added for hanging

FIG. 11 lateral cross-section through mobile, showing the intersection of sheets,

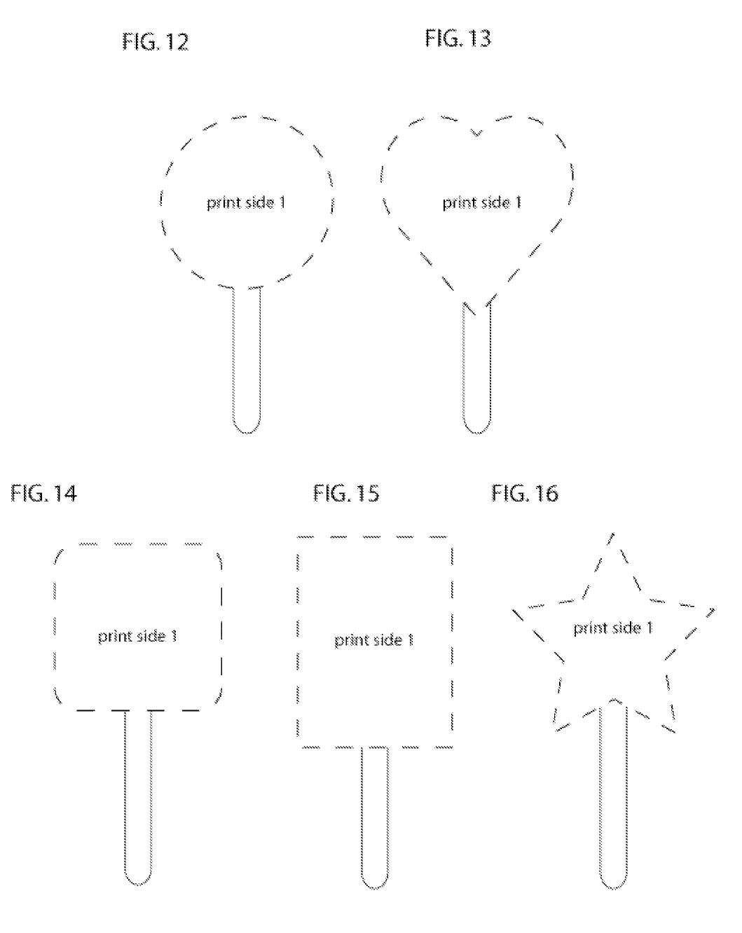

FIGS. 12-16 various shapes for fans that can be applied, but not limited to circles, hearts, squares, rounded corners, rectangles and stars.

### Operation

In operation one uses the sheets as fans, decor, or imprint-able stationery. When this invention is used, the following four effects increase the customization and production of standard hand held fans:

(1) sheets are made of ink jet/laser paper, made for home or office use, increasing production time

(2) pre scored and perforated/die cut, sheets and adhesive backing improves assembly time

(4) pre scored and perforated/die cut, sheets and adhesive backing allow for multiple functions (FIG. 5, FIG. 9, FIG. 10)

(5) when desired, user can print the same artwork on each fan or customize each sheet for a unique application (FIG. 1).

### Advantages

From the description advantages of some my embodiments of my Imprint-able Hand Held Fan/Décor/Stationery Kit become evident:
(a) The adhesive provides a user to create and personalize the material from home with out the need for hot glue, or additional expenses for adhesion
(b) This die cutting allows for a variety of shapes to work with themes for event planning, hosting and more
(c) The paper allows for printing on an ink jet, laser printer, or by hand
(d) The design of the pre-die cut, pre adhesive paper allows for a convenient way for the home designer to customize the fan/decor/stationery kit without the need of costly high quantity print runs, and can save cost and time

1) imprint-able hand held fan/decor/stationery kit

2) substrate made of ink jet/laser paper will be pre-cut/scored and have adhesive backing

3) the substrate will be printed on a home or office ink jet/laser printer

4) the substrate will be separated into a foldable form

5) the foldable form will be assembled for use as a variety of applications including but not limited to: (a) a fan by adding a handle, or (b) imprint-able stationery, or (c) cut and assembled decor such as a mobile
